(19) United States
(12) Patent Application Publication
(10) Pub. No.: US 2006/0045295 A1
(43) Pub. Date: Mar. 2, 2006

(54) Method of and apparatus of reproduce a virtual sound

(76) Inventor: Sun-min Kim, Suwon-si (KR)

Correspondence Address: STANZIONE & KIM, LLP, 919 18TH STREET, N.W., SUITE 440, WASHINGTON, DC, 20006, US

(21) Appl. No.: 11/174,546

(22) Filed: Jul. 6, 2005

(30) Foreign Application Priority Data
Aug. 26, 2004 (KR) 2004-67435

(51) Int. Cl. H04R 5/02

(52) U.S. Cl. 381/310; 381/17

(57) ABSTRACT

A method and an apparatus to reproduce a localized virtual sound source at a position in a 3-D space using multiple channel speakers. The method includes determining position information about the virtual sound source and N speakers, selecting three speakers surrounding the virtual sound source from among the N speakers by calculating N relative angles between the virtual sound source and the N speakers according to the determined position information of the virtual sound source and the N speakers, calculating gains of the selected three speakers and delay values based on distances between each of the selected three speakers, and determining output power values of the N speakers based on the calculated gains and delay values of the respective three speakers.

### CROSS-REFERENCE TO RELATED APPLICATIONS

This application claims priority from Korean Patent Application No. 2004-67435, filed on Aug. 26, 2004, in the Korean Intellectual Property Office, the disclosure of which is incorporated herein in its entirety by reference.

### BACKGROUND OF THE INVENTION

1. Field of the Invention

The present general inventive concept relates to a stereo sound reproducing system, and more particularly, to a method and an apparatus to reproduce a virtual sound localized at a position in a 3-dimensional (3-D) space using multiple channel speakers.

2. Description of the Related Art

A stereo sound system for increasing effectiveness of a virtual reality system, such as a virtual simulator, can be realized by a head-related transfer function (HRTF) using 2-channel speakers or an amplitude panning method using multiple channel speakers.

The amplitude panning method that uses the multiple channel speakers is mainly used for stereo sound systems, since it does not change the timbre of a sound and does not require a large amount of calculation.

Technology related to a vector base amplitude panning (VBAP) method, which is a type of the amplitude panning method, is disclosed in “Ville Pulkki, 6. 1997 entitled Virtual Sound Source Positioning Using Vector Base Amplitude Panning (Ville Pulkki, AES, 1997)”

FIG. 1 is a conceptual diagram illustrating a conventional VBAP method.

Referring to FIG. 1, a plurality of N speakers are arranged in a 3-D space forming a virtual sound space. Localization of a virtual sound source tends to be more accurate when the number of speakers is larger. Speaker powers for the plurality of N speakers are determined by the following processes:

1. Angles between the plurality of N speakers and a virtual sound source to be localized are determined.

2. Gains of the plurality of speakers are determined according to Equation 1 using a base vector of the virtual sound source and base vectors of three speakers selected from among N speakers.

$$[ \begin{matrix}{g}_{1} \\ {g}_{2} \\ {g}_{3}\end{matrix} ] = {[ \begin{matrix}{l}_{11} & {l}_{21} & {l}_{31} \\ {l}_{12} & {l}_{22} & {l}_{32} \\ {l}_{13} & {l}_{23} & {l}_{33}\end{matrix} ]}^{- 1} [ \begin{matrix}{p}_{1} \\ {p}_{2} \\ {p}_{3}\end{matrix} ] \qquad [ Equation 1 ]$$

Here, p=[p₁,p₂,p₃]^{T} indicates a unit vector of the virtual sound source with respect to a listening point (i.e., where the virtual sound source is to be detected), and l₁=[l₁₁,l₁₂,l₁₃]^{T}, l₂=[l₂₁, l₂₂, l₂₃]^{T}, and l₃=[l₃₁, l₃₂, l₃₃]^{T} indicate respective unit vectors of the selected three speakers with respect to the listening point. A unit vector is a normalized vector having a magnitude of 1, and the unit vector indicates an angle of a vector located in the 3-D space.

3. Unit vectors and gains of results are obtained by varying combinations of N speakers according to Equation 1.

4. Typically, only one speaker combination in which all gains are positive exists. Therefore, a virtual sound is reproduced using the selected three speakers Spk1, Spk2, and Spk3 belonging to the speaker combination in which all the gains are positive. A vector k indicates a vector formed between vectors I₂ and I₃.

Since an HRTF is not used in the conventional VBAP method, the timbre is not changed, and realization is easy, since the amount of a calculation required is minimal. However, the unit vectors of the virtual sound source and the selected three speakers are used when the speaker powers are calculated in the conventional VBAP method. Therefore, since only angles are considered and distances of the virtual sound source and the three speakers with respect to the listening point are not considered, localization of the virtual sound decreases when the distances between a listener (i.e., at the listening point) and the selected three speakers change. This localization performance decrease can be described by a stereophonic law of sines, a precedence, or Haas effect.

### SUMMARY OF THE INVENTION

The present general inventive concept provides a virtual sound reproducing method in which localization of a virtual sound source is not decreased even when distances between actual speakers and a listener vary. The method localizes sound by determining powers of the actual speakers by considering the distances between the listener and the actual speakers. The present general inventive concept also provides a virtual sound reproducing apparatus that uses the virtual sound reproducing method.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of reproducing a localized virtual sound source at a position in a 3-D space using multiple channel speakers, the method comprising determining position information about a virtual sound source and N speakers, selecting three speakers surrounding the virtual sound source from among the N speakers by calculating relative angles between the virtual sound source and the respective N speakers according to the determined position information of the virtual sound source and the N speakers, calculating output gains of the selected three speakers and delay values based on distances between each one of the respective selected three speakers with respect to a listening point, and determining output power values of the N speakers based on the calculated output gains and delay values of the respective three speakers.

The foregoing and/or other aspects and advantages of the present general inventive concept may also be achieved by providing a virtual sound reproducing apparatus to localize a virtual sound source at a position in a 3-D space using multiple channel speakers, the apparatus comprising a memory to store position information about N speakers and a sound source file, a virtual sound signal processor to select three speakers surrounding the virtual sound source from among the N speakers according to the position information of the N speakers and input position information about the virtual sound source and to set output power values of the N speakers based on power gains of the selected three speakers and delay values based on distances between each one of the selected three speakers and a listening point, and an amplifier to amplify sound source signals generated by the N speakers according to the output power values set by the virtual sound signal processor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a conceptual diagram illustrating a conventional VBAP method used to reproduce virtual sound;

FIG. 2 is a block diagram illustrating a virtual sound reproducing apparatus according to an embodiment of the present general inventive concept;

FIG. 3 is a flowchart illustrating a virtual sound reproducing method performed by a virtual sound signal processor of FIG. 2; and

FIG. 4 is a conceptual diagram illustrating the virtual sound reproducing method of FIG. 3.

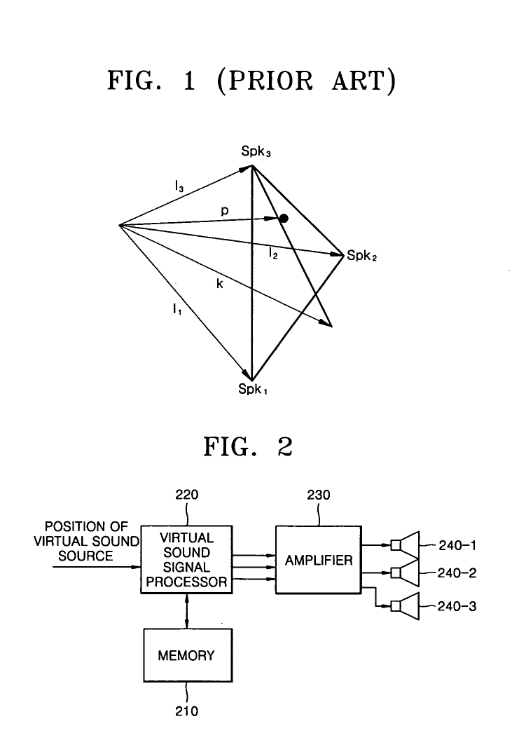

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 2 is a block diagram illustrating a virtual sound reproducing apparatus according to an embodiment of the present general inventive concept.

Referring to FIG. 2, the virtual sound reproducing apparatus includes a memory 210, a virtual sound signal processor 220, an amplifier 230, and three speakers 240-1, 240-2, and 240-3.

The memory 210 stores position information about N speakers and a sound source file. The sound source file contains information about one or more virtual sounds to be localized at one or more virtual sound sources.

The virtual sound signal processor 220 calculates relative angles between a virtual sound source and the N speakers according to the position information about the N speakers stored in the memory 210 and input position information about the virtual sound source. The virtual sound signal processor 220 then selects the three speakers surrounding the virtual sound source 240-1, 240-2, and 240-3 from among the N speakers. The virtual sound signal processor 220 then calculates power amplitudes of the selected three speakers 240-1, 240-2, and 240-3 and time delay values based on distances between each one of the selected three speakers with respect to a listening point (i.e., where the virtual sound source is heard), and determines output power values of the N speakers. Therefore, the virtual sound signal processor 220 outputs the sound source file stored in the memory 210 to three channels according to the output power values of the N speakers. In other words, the virtual sound signal processor 220 individually processes each of the virtual sounds in the sound source file according to the position information about the plurality of N speakers and the position information about each individual virtual sound source. Thus, depending on the position information about the virtual sound source, different virtual sounds are reproduced using different sets of speakers selected from among the N plurality of speakers. The number of relative angles may be N.

The amplifier 230 amplifies sound source signals generated by the powers of the N speakers determined by the virtual sound signal processor 220.

The selected three speakers 240-1, 240-2, and 240-3 reproduce the sound source signals amplified by the amplifier 230.

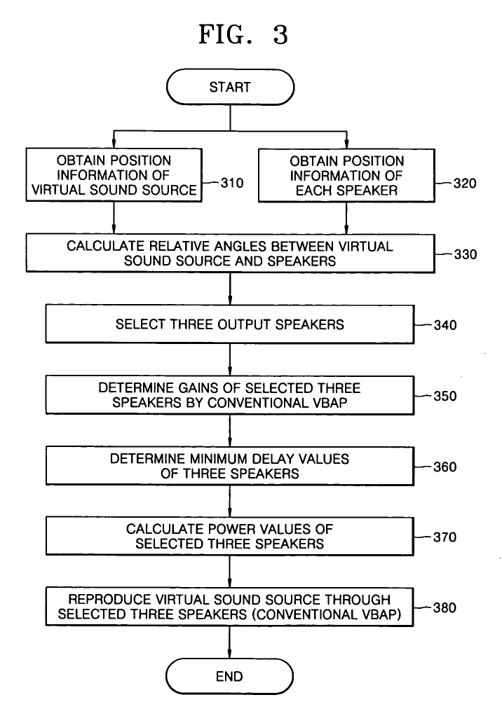

FIG. 3 is a flowchart illustrating a virtual sound reproducing method performed by the virtual sound signal processor 220 of FIG. 2.

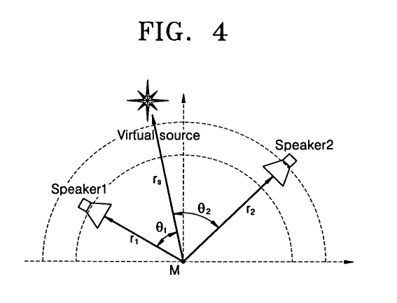

To derive an equation of a 3-D space amplitude panning method according to the present general inventive concept, a plane illustrated in FIG. 4 is expanded into a 3-D space.

A 3-D position vector of the listening point (i.e., a head center of a listener where the virtual sound is to be detected) M to listen to a virtual sound source located in the 3-D space is defined as r_{S} (FIG. 4) in operation 310, and position vectors of the N speakers having distances from the listening point M that are different are defined as rᵢ (FIG. 4) (i=1, 2, . . . , N) in operation 320.

The N relative angles between the virtual sound source and the N respective speakers are calculated using Equation 2 in operation 330.

$${θ}_{1} = {cos}^{- 1} ( \frac{{r}_{i}^{T} {r}_{s}}{‖ {r}_{i} ‖ ‖ {r}_{s} ‖} ) , i = 1 , 2 , ⋯ , N \qquad [ Equation 2 ]$$

Three speakers corresponding to the three smallest angles among the N relative angles calculated in the operation 330 are selected in operation 340. These three speakers correspond to speakers surrounding a virtual sound source and are used for actual outputs. For example, the three selected speakers correspond to the speakers 240-1, 240-2, and 240-3 of FIG. 2.

In a case where a sound pressure of a virtual mono sound source is p_{S}, a sound pressure p_{SM} when a sound output from the virtual sound source reaches the listening point M is determined by Equation 3 using a free sound field function.

$${p}_{sM} = \frac{1}{{r}_{s}} {ⅇ}^{- j {kr}_{s}} {p}_{s} \qquad [ Equation 3 ]$$

Here, k indicates a wave number and r_{S} indicates a distance between the listening point M and the virtual sound source. In a case where rᵢ indicates a distance between the listening point M and each of the respective three speakers and pᵢ indicates output sound pressures (i.e., output power values) of the respective three speakers selected according to Equation 2, sound pressures (i.e., sound power values) p_{iM} when sounds output from the three respective speakers reach the listening point M are determined by Equation 4 in the free sound field function.

$${p}_{iM} = \frac{1}{{r}_{i}} {ⅇ}^{- j {kr}_{i}} {p}_{i} , i = 1 , 2 , 3 \qquad [ Equation 4 ]$$

When the respective output power values pᵢ of the three respective speakers are determined, the affect of distances between the virtual sound source and the listening point M and between the three speakers and the listening point M is accounted for by Equations 3 and 4. Therefore, since only angles can be considered with respect to p_{SM} and p_{iM} in which the respective distances are accounted for the sound power values p_{iM} at the listening point M can be determined using Equation 5 according to a conventional amplitude panning method. Also, a gain gᵢ of each of the respective three speakers is obtained using the conventional amplitude panning method in operation 350.
p_{iM}=αgᵢp_{sM}, i=1,2,3 [Equation 5]

Here, α indicates a scaling factor to correct a power difference between the virtual sound source and the three speakers, and gᵢ indicates the gain of each of the three respective speakers obtained according to the conventional amplitude panning method in the operation 350. In order to make the power of the virtual sound source and the sound power value of the three speakers the same at the listening point M, Equation 6 is satisfied.
p_{sM}²=p_{1M}²+p_{2M}²+p_{3M}²

If Equation 5 is substituted into Equation 6, the scaling factor α used to correct the power difference between the virtual sound source and the three speakers is obtained according to Equation 7.

$$α = \sqrt{\frac{1}{{g}_{1}^{2} + {g}_{2}^{2} + {g}_{3}^{2}}} \qquad [ Equation 7 ]$$

If Equations 3 and 4 are substituted into Equation 5, the output power values pᵢ of each of the respective three speakers is inversely proportional to the distance of the virtual sound source from the listening point M, and is proportional to the distance of each speaker from the listening point M. The output power values pᵢ of the three respective speakers are represented in Equation 8 with the scaling factor α and a time delay term that depends on the distance of each speaker from the listening point M rᵢ.

$${p}_{i} = α {g}_{i} \frac{{r}_{i}}{{r}_{s}} {ⅇ}^{- j k ( {r}_{s} - {r}_{i} )} {p}_{s} , i = 1 , 2 , 3 \qquad [ Equation 8 ]$$

The time delay is defined by Equations 9.
Δᵢ=(rₛ−rᵢ)Fₛ/c
e^{-jk(r}^{ₛ}^{-r}^{ᵢ}⁾=e^{-jωΔ}^{ᵢ},|ω|<π [Equations 9]

Here, F_{S} indicates a sampling frequency, and c indicates a propagation speed of sound. The output power values (i.e., the output sound pressure) of the three respective speakers in a discrete-time domain pᵢ (n) are obtained by multiplying a specific magnitude pᵢ and a specific time delay Δᵢ (i.e., the time delay of the respective speaker) by the sound pressure p_{S} of the virtual sound source as indicated in Equation 10.

$${p}_{i} ( n ) = α {g}_{i} \frac{{r}_{i}}{{r}_{s}} {p}_{s} ( n - {Δ}_{i} ) , i = 1 , 2 , 3 \qquad [ Equation 10 ]$$

Here, if the virtual sound source is much further away from the listening point M than the respective three speakers (i.e., the virtual sound source is far from the three speakers), a value of Δᵢ is very large. Accordingly, an unnecessary time delay is generated. On the other hand, if the virtual sound source is closer to the listening point M than the than the distance between the listening point and the three respective speakers (i.e., rₛ is smaller than rᵢ), the value of the time delay Δᵢ is negative. Accordingly, a future value of the sound pressure of the virtual sound source p_{S} would be required. In order to avoid the problems that result from requiring the future value of the virtual sound source p_{S}, a minimum value of the time delay (i.e., min(Δᵢ)) is set to 0 using Equation 11 in operation 360.
dᵢ=Δᵢ−min(Δᵢ), i=1, 2, 3 [Equation 11]

Finally, the output power values of the three respective speakers are determined by Equation 12 in operation 370.

$${p}_{i} = \sqrt{\frac{{g}_{i}^{2}}{{g}_{i}^{2} + {g}_{2}^{2} + {g}_{3}^{2}}} \frac{{r}_{i}}{{r}_{s}} {p}_{s} ( n - {d}_{i} ) , i = 1 , 2 , 3 \qquad [ Equation 12 ]$$

Here, p_{S} indicates the sound pressure of the virtual mono sound source, gᵢ indicates the gain of each of the three respective speakers obtained according to the conventional amplitude panning method, and dᵢ is the time delay having 0 as the minimum value. The time delay value dᵢ is converted into an integer value by rounding off numbers to one decimal place, since dᵢ is typically not an integer. In order to more accurately calculate the time delay, a non-integer delay term may be calculated with a sine function using Equation 13. Here, a method of calculating the non-integer delay term is described in “Discrete-Time Signal Processing, Alan V. Oppenheim, Ronal W. Schafer, pp. 100-101, Prentice-Hall.”

$${p}_{i} = \sqrt{\frac{{g}_{i}^{2}}{{g}_{1}^{2} + {g}_{2}^{2} + {g}_{3}^{2}}} \frac{{r}_{i}}{{r}_{s}} {\sum }_{k = - ∞}^{∞} \frac{sin ( π ( n - k - {Δ}_{i} ) )}{π ( n - k - {Δ}_{i} )} {p}_{s} ( k ) , i = 1 , 2 , 3 \qquad [ Equation 13 ]$$

As shown in Equation 13, the output power values of the three respective speakers are determined considering differences between the calculated gains of the three speakers and differences between time delays generated by different distances of each one of the three speakers from the listening point M.

A virtual stereo sound is reproduced through the three speakers using the conventional VBAP according to the output power values of the three speakers determined in operation 380.

A process of obtaining the output power values of three speakers according to an embodiment of the present general inventive concept includes the following operations, for example: (1) if a position of a virtual sound source in a 3-D space is determined, three speakers surrounding the virtual sound source are determined by Equation 2 according to positions of a plurality of speakers, (2) a gain gᵢ of each of the three respective speakers is obtained according to the conventional VBAP method using unit vectors of the three respective speakers, and (3) output power values of the three respective speakers are determined according to Equations 9, 11, and 12.

Although the above description refers to the VBAP method, it should be understood that the present general inventive concept can be applied with other amplitude panning methods. Additionally, although the above description refers to reproducing the virtual sound using three speakers, other numbers of speakers may also be used with the present general inventive concept.

The general inventive concept can be implemented as computer-readable codes on a computer-readable recording medium. The computer-readable recording medium may include any data storage device that can store data which can be thereafter read by a computer system. Examples of the computer-readable recording medium include read-only memory (ROM), random-access memory (RAM), CD-ROMs, magnetic tapes, floppy disks, flash memory, optical data storage devices, and carrier waves (such as data transmission through the Internet). The computer-readable recording medium can also be distributed over network coupled computer systems so that the computer-readable code is stored and executed in a distributed fashion.

As described above, in conventional virtual sound reproducing methods, localization decreases when a distance between a listener and each actual speaker changes, since conventional virtual sound reproducing methods determine output powers of the actual speakers by considering only angles of the actual speakers with respect to a virtual sound source. In contrast, the virtual sound reproducing method according to an embodiment of the present general inventive concept considers both the distances between the listener and the actual speakers and the angles of the actual speakers with respect to the virtual sound source. As a result, localization does not decrease even when the actual speakers are freely arranged according to an installation space, a timbre is not changed, and realization is easy.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of reproducing a localized virtual sound source at a position in a 3-D space using multiple channel speakers, the method comprising:
determining position information about a virtual sound source and N speakers;
selecting three speakers surrounding the virtual sound source from among the N speakers by calculating relative angles between the virtual sound source and the respective N speakers according to the determined position information of the virtual sound source and the N speakers;
calculating output gains of the selected three speakers and time delay values based on distances between each one of the selected three speakers with respect to a listening point; and
determining output power values of the N speakers based on the calculated output gains and time delay values of the respective selected three speakers.

2. The method of claim 1, wherein the relative angles comprise smallest three angles from among the relative angles between the virtual sound source and the N speakers, and the selecting of the three speakers comprises:
selecting the three speakers that correspond to the smallest three angles.

3. The method of claim 2, wherein the relative angles between the virtual sound source and the N speakers are calculated by
$${θ}_{1} = {cos}^{- 1} ( \frac{{r}_{i}^{T} {r}_{s}}{‖ {r}_{i} ‖ ‖ {r}_{s} ‖} ) , i = 1 , 2 , ⋯ , N$$
where rᵢ indicates a position vector between each of the respective N speakers and the listening point, and r_{S} indicates a 3-D position vector of the listening point to the virtual sound source located in the 3-D space.

4. The method of claim 1, wherein the output power values of the selected three speakers are determined by power amplitudes and the time delay values.

5. The method of claim 4, wherein the output power values of the selected three speakers are defined as pᵢ(n)=aᵢp_{S}(n−bᵢ),i=1,2,3,
where aᵢ indicates the output gains of respective ones of the selected three speakers, bᵢ indicates the time delay values based on distances between the respective ones of the three speakers and the listening point and between the virtual sound source and the listening point, p_{S} indicates a sound pressure of a virtual mono sound source, and pᵢ indicates the output power values of each of the respective three speakers.

6. The method of claim 4, wherein the output power values of the respective three speakers are obtained by
$${p}_{i} = \sqrt{\frac{{g}_{i}^{2}}{{g}_{1}^{2} + {g}_{2}^{2} + {g}_{3}^{2}}} \frac{{r}_{i}}{{r}_{s}} {p}_{s} ( n - {d}_{i} ) , i = 1 , 2 , 3$$
where gᵢ indicates the output gains of each of the respective three speakers obtained by a VBAP algorithm, r_{S} indicates a distance between the listening point and the virtual sound source, rᵢ indicates a distance between the listening point and each of the respective three speakers, and dᵢ indicates the time delay values of the respective three speakers and is defined by
di=Δi−min(Δi), i=1,2,3
where Δᵢ=(rₛ−rᵢ)Fₛ/c F_{S} indicates a sampling frequency, and c indicates a speed of sound.

7. The method of claim 6, wherein the time delay value dᵢ is converted into an integer value by rounding off numbers to one decimal place.

8. The method of claim 4, wherein the output power values of the respective three speakers are obtained by
$${p}_{i} = \sqrt{\frac{{g}_{i}^{2}}{{g}_{1}^{2} + {g}_{2}^{2} + {g}_{3}^{2}}} \frac{{r}_{i}}{{r}_{s}} {\sum }_{k = - ∞}^{∞} \frac{sin ( π ( n - k - {Δ}_{i} ) )}{π ( n - k - {Δ}_{i} )} {p}_{s} ( k ) , i = 1 , 2 , 3$$
where gᵢ indicates the output gains of the respective three speakers obtained by a VBAP algorithm, r_{S} indicates a distance between the listening point and the virtual sound source, rᵢ indicates a distance between the listening point and each of the respective three speakers, dᵢ indicates the time delay values of the respective three speakers, p_{S} indicates a sound pressure of a virtual mono sound source, pᵢ indicates the output power values of each of the respective three speakers, and Δᵢ=(r_{S}−rᵢ)F_{S}/c where F_{S} indicates a sampling frequency and c indicates a speed of sound.

9. A method of reproducing one or more localized virtual sounds in a multiple channel speaker system having N speakers, the method comprising:
selecting a plurality of the N speakers to reproduce a virtual sound at a predetermined sound location to be detected at a listening point according to angle information about the N speakers with respect to the predetermined sound location; and
determining output power values of the selected plurality of speakers according to the angle information about the selected plurality of speakers and distance information of the selected plurality of speakers with respect to the listening point.

10. The method of claim 9, wherein the multiple channel speaker system is three dimensional.

11. The method of claim 9, wherein the listening point corresponds to a center of a listener's head, and the angle information comprises N relative angles of the N speakers with respect to a line formed by the listening point and the virtual sound.

12. The method of claim 9, wherein the selecting of the plurality of speakers comprises selecting speakers that are close to the predetermined sound location according to their respective angle information.

13. The method of claim 9, further comprising:
amplifying sound signals of channels corresponding to the selected plurality of speakers according to the determined output power values of the selected plurality of speakers.

14. The method of claim 9, wherein the selected plurality of speakers comprises three or more speakers of different channels having smallest angular distances from the predetermined sound location.

15. The method of claim 9, further comprising:
determining position information of the virtual sound by reading a sound source file from a memory.

16. The method of claim 9, wherein the determining of the output power values of the selected plurality of speakers comprises:
calculating expected power values at the listening point of the respective ones of the selected plurality of speakers used to reproduce the virtual sound at the predetermined sound location;
determining the distance information of the respective ones of the selected plurality of speakers with respect to the listening point; and
defining initial output power values for the respective ones of the selected plurality of speakers according to the angle information of the selected plurality of speakers, the distance information of the respective ones of the selected plurality of speakers, and the expected power values at the listening point of the respective ones of the selected plurality of speakers.

17. The method of claim 16, wherein the determining of the distance information comprises:
determining distances between the respective ones of the selected plurality of speakers and the listening point and a distance between the predetermined sound location and the listening point; and
determining time delay values between each of the respective ones of the selected plurality of speakers and the listening point according to the respective distances of the selected plurality of speakers and the distance of the predetermined sound location.

18. The method of claim 17, wherein the determining of the output power values of the selected plurality of speakers further comprises:
determining a power gain of each of the selected plurality of speakers using a vector based amplitude panning process.

19. The method of claim 17, wherein the determining of the distance information further comprises:
setting a minimum time delay value to zero.

20. The method of claim 9, wherein the determining of the output power values of the selected plurality of speakers comprises:
accounting for an exponential decrease in the output power value based on the distance information with respect to the listening point of the selected plurality of speakers.

21. The method of claim 9, further comprising:
storing position information about the N speakers in a memory; and
selecting a second plurality of the N speakers according to position information of a second virtual sound and the position information about the N speakers.

22. A method of reproducing a localized virtual sound in a multiple channel speaker system having N speakers, the method comprising:
selecting a plurality of the N speakers according to angle information about the N speakers and a virtual sound source;
determining power gains of the selected plurality of speakers according to the angle information;
determining minimum time delay values of the selected plurality of speakers according to distance information about the selected plurality of speakers and the virtual sound source;
calculating output power values of the selected plurality of speakers according to the minimum time delay values and the power gains of the selected plurality of speakers; and
reproducing the virtual sound source through the selected plurality of speakers according to the calculated output power values.

23. A virtual sound reproducing apparatus to localize a virtual sound source at a position in a 3-D space using multiple channel speakers, the apparatus comprising:
a memory to store position information about N speakers and a sound source file;
a virtual sound signal processor to select three speakers surrounding the virtual sound source from among the N speakers according to the position information of the N speakers and input position information about the virtual sound source and to set output power values of the N speakers based on power gains of the selected three speakers and time delay values based on distances between each one of the selected three speakers and a listening point; and
an amplifier to amplify sound source signals generated by the N speakers according to the output power values set by the virtual sound signal processor.

24. The apparatus of claim 23, wherein the virtual sound signal processor comprises:
a speaker selection unit to calculate N relative angles between the virtual sound source and the respective N speakers according to the position information of the virtual sound source and the N speakers and to select the three speakers corresponding to the smallest three angles from among the N relative angles;
an amplitude calculation unit to calculate the power gains of the selected three speakers and the time delay values based on distances between each one of the selected three speakers and the listening point; and
a power determining unit to determine the output power values of the speakers according to the calculated gains and time delay values of the selected three speakers.

25. An apparatus to reproduce one or more localized virtual sounds in a multiple channel speaker system having N speakers, comprising:
a virtual sound signal processor, comprising:
a selection unit to select a plurality of the N speakers to reproduce a virtual sound at a predetermined sound location to be detected at a listening point according to angle information about the N speakers with respect to the predetermined sound location, and
a determination unit to determine output power values of the selected plurality of speakers according to the angle information about the selected plurality of speakers and distance information of the selected plurality of speakers with respect to the listening point.

26. The apparatus of claim 25, wherein the multiple channel speaker system is three dimensional.

27. The apparatus of claim 25, wherein the listening point corresponds to a center of a listener's head.

28. The apparatus of claim 25, wherein the selection unit selects speakers that are close to the predetermined sound location according to their respective angle information.

29. The apparatus of claim 25, further comprising:
an amplifier to amplify sound signals of channels corresponding to the selected plurality of speakers according to the determined output power values of the selected plurality of speakers.

30. The apparatus of claim 25, wherein the selected plurality of speakers comprises three or more speakers of different channels having smallest angular distances from the predetermined sound location.

31. The apparatus of claim 25, further comprising:
a memory to store a sound source file having position information of the virtual sound.

32. The apparatus of claim 25, further comprising:
a memory to store position information about the N speakers,
wherein the selection unit selects a second plurality of the N speakers according to position information of a second virtual sound and the position information about the N speakers.

33. The apparatus of claim 25, wherein the determination unit determines the output power values of the selected plurality of speakers by calculating expected power values at the listening point of the respective ones of the selected plurality of speakers used to reproduce the virtual sound at the predetermined sound location, determining the distance information of the respective ones of the selected plurality of speakers with respect to the listening point, and defining initial output power values for the respective ones of the selected plurality of speakers according to the angle information of the selected plurality of speakers, the distance information of the respective ones of the selected plurality of speakers, and the expected power values at the listening point of the respective ones of the selected plurality of speakers.

34. The apparatus of claim 33, wherein the determination unit determines the distance information by determining distances between the respective ones of the selected plurality of speakers and the listening point and a distance between the predetermined sound location and the listening point, and determining time delay values between each of the respective ones of the selected plurality of speakers and the listening point according to the respective distances of the selected plurality of speakers and the distance of the predetermined sound location.

35. The apparatus of claim 34, wherein the determination unit determines the output power values of the selected plurality of speakers by further determining a power gain of each of the selected plurality of speakers using a vector based amplitude panning process.

36. The apparatus of claim 34, wherein the determination unit further sets a minimum time delay value to zero.

37. The apparatus of claim 25, wherein the determination unit determines the output power values of the selected plurality of speakers by further accounting for an exponential decrease in the output power value based on the distance information with respect to the listening point of the selected plurality of speakers.

38. A computer readable medium including computer readable code to reproduce a localized virtual sound source at a position in a 3-D space using multiple channel speakers, the medium comprising:
a first computer readable code to determine position information about a virtual sound source and N speakers;
a second computer readable code to select three speakers surrounding the virtual sound source from among the N speakers by calculating relative angles between the virtual sound source and the respective N speakers according to the determined position information of the virtual sound source and the N speakers;
a third computer readable code to calculate output gains of the selected three speakers and delay values based on distances between each one of the selected three speakers with respect to a listening point; and
a fourth computer readable code to determine output power values of the N speakers based on the calculated gains and time delay values of the respective selected three speakers.

39. A computer readable medium to reproduce one or more localized virtual sounds in a multiple channel speaker system having N speakers, the medium comprising:
a first computer readable code to select a plurality of the N speakers to reproduce a virtual sound at a predetermined sound location to be detected at a listening point according to angle information about the N speakers with respect to the predetermined sound location; and
a second computer readable code to determine output power values of the selected plurality of speakers according to the angle information about the selected plurality of speakers and distance information of the selected plurality of speakers with respect to the listening point.
